(19) United States
(12) Patent Application Publication
(10) Pub. No.: US 2018/0189177 A1
(43) Pub. Date: Jul. 5, 2018

(54) DISTRIBUTED DATA OBJECT MANAGEMENT METHOD AND APPARATUS

(71) Applicant: Intel Corporation, Santa Clara, CA (US)

(72) Inventors: Francesc Guim Bernat, Barcelona (ES); Kshitij A. Doshi, Tempe, AZ (US); Mark A. Schmisseur, Phoenix, AZ (US); Steen Larsen, Portland, OR (US); Chet R. Douglas, Tucson, AZ (US)

(21) Appl. No.: 15/394,667

(22) Filed: Dec. 29, 2016

(51) Int. Cl. G06F 12/06; H04L 29/08; G06F 12/0802

(52) U.S. Cl. CPC G06F 12/06; H04L 67/1095; G06F 2212/60; G06F 12/0802; H04L 67/06

(57) ABSTRACT

Apparatus and method for distributed management of data objects in a network of compute nodes are disclosed herein. A first compute node interface may be communicatively coupled to a first compute node to receive a request from the first compute node for at least a portion of a particular version of a data object, wherein the first compute node interface is to include mapping information and logic, wherein the logic is to redirect the request to a second compute node interface associated with a second compute node when the second compute node is mapped to a plurality of data object addresses that includes an address associated with the data object in accordance with the mapping information, and wherein the first compute node is to receive, as a response to the request, the at least a portion of the particular version of the data object from a third compute node interface associated with a third compute node.

### FIELD OF THE INVENTION

The present disclosure relates generally to the technical fields of computing and networks, and more particularly, to data object management within a networked cluster of compute nodes, e.g., compute nodes in a data center.

### BACKGROUND

The background description provided herein is for the purpose of generally presenting the context of the disclosure. Unless otherwise indicated herein, the materials described in this section are not prior art to the claims in this application and are not admitted to be prior art or suggestions of the prior art, by inclusion in this section.

A data center network may include a plurality of compute nodes which may generate, use, modify, and/or delete a large number of data objects (e.g., files, documents, pages, etc.). The plurality of compute nodes may comprise processor nodes, storage nodes, input/output (I/O) nodes, and the like, each configured to perform one or more particular functions or particular types of functions. In the course of performance of functions by the compute nodes, data objects may be communicated between select compute nodes; version(s) of data objects may be stored at select compute nodes; and data objects may also be modified or deleted, different versions of data objects may be generated, new data objects may be generated, and other changes to data objects may occur.

Accordingly, data objects within the network of compute nodes may be required to be tracked so that different versions of data objects, cache locations of data objects, and the like may be known in order for accurate and proper versions of data objects to be used by the compute nodes. While tracking may be performed using software based schemes, software based tracking tends to be expensive, cumbersome, prone to latencies, and/or may have significant overhead requirements (e.g., processor cycles, cache use, messaging, etc.).

### BRIEF DESCRIPTION OF THE DRAWINGS

Embodiments will be readily understood by the following detailed description in conjunction with the accompanying drawings. The concepts described herein are illustrated by way of example and not by way of limitation in the accompanying figures. For simplicity and clarity of illustration, elements illustrated in the figures are not necessarily drawn to scale. Where considered appropriate, like reference labels designate corresponding or analogous elements.

FIG. 1 depicts a block diagram illustrating a network view of an example system incorporated with a scalable distributed data object management mechanism of the present disclosure, according to some embodiments.

FIG. 2 illustrates an example depiction of mappings between a data object address space and the plurality of compute nodes included in the system of FIG. 1, according to some embodiments.

FIGS. 3A-3B depict an example process to fulfill a request for a particular version of a particular data object made by a particular compute node included in the system of FIG. 1 using the scalable distributed data object management mechanism, according to some embodiments.

FIG. 4 depicts an example illustration showing a pathway followed among components of the system of FIG. 1 to fulfill a request for a particular version of a particular data object in accordance with the process of FIGS. 3A-3B, according to some embodiments.

FIG. 5 depicts a diagram illustrating an example process for data object creation, according to some embodiments.

FIG. 6 depicts a diagram illustrating an example process for registering a data object, according to some embodiments.

FIG. 7 depicts a diagram illustrating an example process for deregistering a data object, according to some embodiments.

FIG. 8 depicts a diagram illustrating an example process to obtain a list of sharers of a particular data object and the known versions of the particular data object held by the respective sharers, according to some embodiments.

FIG. 9 depicts a diagram illustrating an example process to obtain the value or content of a particular version of a particular data object, according to some embodiments.

FIG. 10 depicts a diagram illustrating an example process for updating a data object, according to some embodiments.

FIG. 11 depicts a diagram illustrating an example process for deleting a data object, according to some embodiments.

FIG. 12 illustrates an example computer device suitable for use to practice aspects of the present disclosure, according to some embodiments.

FIG. 13 illustrates an example non-transitory computer-readable storage media having instructions configured to practice all or selected ones of the operations associated with the processes described herein, according to some embodiments.

### DETAILED DESCRIPTION

Embodiments of apparatuses and methods related to distributed management of data objects in a network of compute nodes are described. In some embodiments, a first compute node interface may be communicatively coupled to a first compute node to receive a request from the first compute node for at least a portion of a particular version of a data object, wherein the first compute node interface is to include mapping information and logic, wherein the logic is to redirect the request to a second compute node interface associated with a second compute node when the second compute node is mapped to a plurality of data object addresses that includes an address associated with the data object in accordance with the mapping information. The first compute node is to receive, as a response to the request, the at least a portion of the particular version of the data object from a third compute node interface associated with a third compute node. These and other aspects of the present disclosure will be more fully described below.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). As used herein, the term “logic” and “module” may refer to, be part of, or include an application specific integrated circuit (ASIC), an electronic circuit, a processor (shared, dedicated, or group), and/or memory (shared, dedicated, or group) that execute one or more software or firmware programs having machine instructions (generated from an assembler and/or a compiler), a combinational logic circuit, and/or other suitable components that provide the described functionality.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

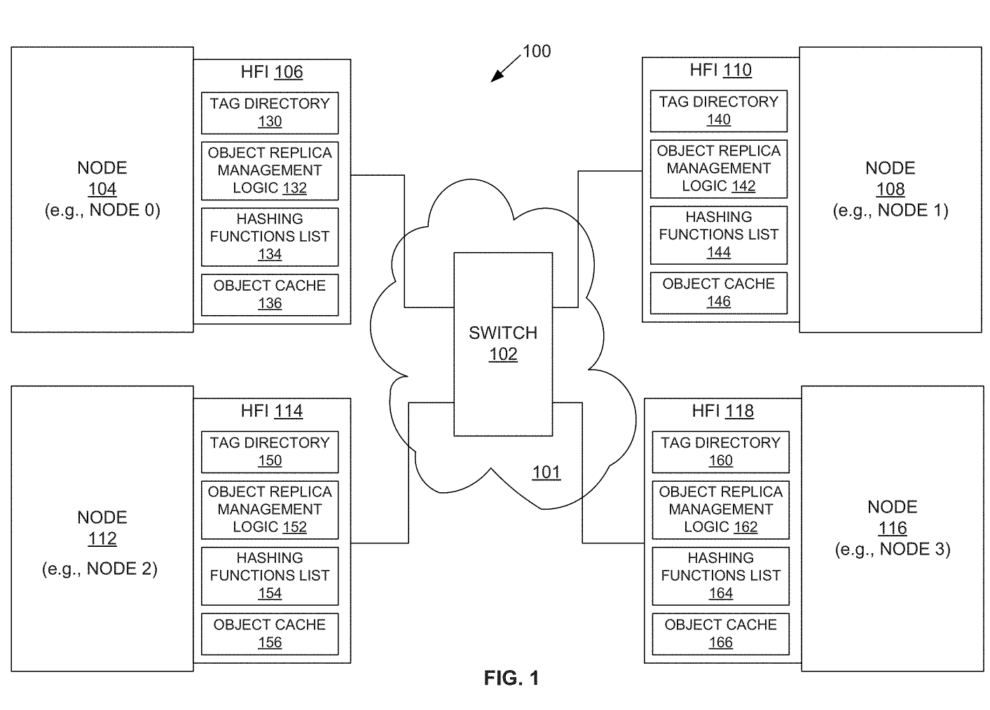

FIG. 1 depicts a block diagram illustrating a network view of an example system 100 incorporated with a scalable distributed data object management mechanism of the present disclosure, according to some embodiments. System 100 may comprise a computing network, a data center, a computing fabric, and the like. In some embodiments, system 100 may include a network 101 that includes one or more switches, such as a switch 102; a plurality of compute nodes (also referred to as nodes) 104, 108, 112, 116; and a plurality of compute node interfaces (also referred to as host fabric interfaces (HFIs)) 106, 110, 114, 118. Compute node interfaces 106, 110, 114, 118 may couple to the network 101, and in particular, to switch 102. Compute node interfaces 106, 110, 114, 118 may couple to respective compute nodes 104, 108, 112, 116.

In some embodiments, network 101 may comprise switches, routers, firewalls, relays, interconnects, network management controllers, servers, memory, processors, and/or other components configured to interconnect compute nodes 104, 108, 112, 116 to each other and facilitate their operation. Without limitation, data objects, messages, and other data may be communicated between one compute node to another compute node of the plurality of compute nodes 104, 108, 112, 116. FIG. 1 depicts switch 102 as an example network 101 component, but it is understood that network 101 is not so limited and additional and/or other components of the network 101 may couple to the compute node interfaces 106, 110, 114, 118 to facilitate communication between the compute nodes 104, 108, 112, 116. The network 101 may also be referred to as a fabric, compute fabric, or cloud. And the switch 102 may also be referred to as a fabric switch or master switch.

Each compute node of the plurality of compute nodes 104, 108, 112, 116 may include one or more compute components such as, but not limited to, servers, processors, memory, disk memory, solid state memory, processing servers, memory servers, routers, switches, gateways, relays, repeaters, and/or the like configured to provide at least one particular process or network service. A compute node may comprise a physical compute node, in which its compute components may be located proximate to each other, or a logical compute node, in which its compute components may be distributed geographically from each other such as in cloud computing environments. Similarly, compute nodes 104, 108, 112, 116 may be geographically proximate or distributed from each other. Compute nodes 104, 108, 112, 116 may comprise processer compute nodes, memory compute nodes, input/output (I/O) compute nodes, intermediating compute nodes, and/or the like. Compute nodes 104, 108, 112, 116 may be the same or different from each other. Compute nodes 104, 108, 112, 116 may also be referred to as nodes, network nodes, or fabric nodes. More or less than four compute nodes may be included in system 100. For example, system 100 may include hundreds or thousands of compute nodes.

As an example, compute nodes 104, 108, 112, and 116 may also be respectively referred to as node 0, node 1, node 2, and node 3, as shown in FIG. 1. Moreover, compute node 104 may comprise one or more processors, compute node 108 may comprise a memory server, compute node 112 may comprise storage (e.g., disk servers), and compute node 116 may comprise one or more processors with associated memories. Moreover, compute node 116 may include more than one type or tiers of memories such as, but not limited to, double data rate (DDR) memory, high bandwidth memory (HBM), solid state memory, solid state drive (SSD), and the like.

A plurality of data objects may be generated, modified, used, and/or stored within the system 100. Data objects (also referred to as objects) may comprise, without limitation, files, pages, documents, tuples, or any units of data. Particular data objects may be sourced at certain of the compute node(s) while used and/or modified, in some cases, frequently, by certain other of the compute node(s). Continuing the example, data objects may be sourced or stored in compute node 112 comprising storage, while processor compute nodes 104 and/or 116 may access such data objects to perform one or more processing functions. Moreover, frequently used and/or large data objects may be locally cached, even though the data objects may officially be maintained elsewhere, to facilitate quick access. One or more versions of a given data object may thus arise when local caching may be practiced.

In some embodiments, management of data objects used by compute nodes 104, 108, 112, 116 may be performed by one or more of the compute node interfaces 106, 110, 114, 118. Management of data objects may comprise, without limitation, tracking, caching, steering, and other functions associated with providing data objects to the compute nodes 104, 108, 112, 116. By offloading the burden of managing data objects to participating ones of the compute node interfaces 106, 110, 114, 118, rather than having the compute nodes 104, 108, 112, 116 perform such functions, overhead may be proportional to the degree to conflicting data object accesses. Among other things, for light or high contended data objects, embodiments of the present disclosure may provide improved ease in obtaining cache behavior information associated with data objects, similar to access of private and/or locally cached data objects. In addition to improvements in efficiency and response time over, for example, software based schemes, scalability may also be provided by embodiments of the data object management mechanism described herein. For ease of understanding, and not limitation, the remaining description will be presented with compute nodes 104, 108, 112, 116 offloading data object management functions to compute node interfaces 106, 110, 114, 118.

Each of the compute node interfaces 106, 110, 114, 118 may include, without limitation, a tag directory (also referred to an object tag directory or a data object tag directory), an object replica management logic (also referred to as a data object replica management logic), a hashing functions list, and an object cache (also referred to as a data object cache), according to some embodiments. Tag directory, object replica management logic, hashing functions list, and/or the object cache may be communicatively coupled to each other. For example, without limitation, the object replica management logic may be communicatively coupled to each of the tag directory, hashing functions list, and object cache. As shown in FIG. 1, compute node interface 106 may include a tag directory 130, an object replica management logic 132, a hashing functions list 134, and an object cache 136; compute node interface 110 may include a tag directory 140, an object replica management logic 142, a hashing functions list 144, and an object cache 146; compute node interface 114 may include a tag directory 150, an object replica management logic 152, a hashing functions list 154, and an object cache 156; and compute node interface 118 may include a tag directory 160, an object replica management logic 162, a hashing functions list 164, and an object cache 166.

In some embodiments, the tag directory, object replica management logic, hashing functions list, and object cache included in each of the compute node interfaces 106, 110, 114, 118 may perform at least three functions—tracking, steering, and caching—associated with data objects within the system 100. A compute node interface may be configured to track data objects and versions of data objects, and provide specific versions of data objects requested by a compute node via (local) caching or redirection/steering to appropriate other compute node interfaces, as described in detail below.

It is contemplated that embodiments of the scalable distributed data object management mechanism may be capable of tracking, steering, caching, and/or performing other functions as described herein at a granularity level which may be at a data object level, a data object portion or subpart level, and/or a more than one data object level for any version of respective data objects. For example, although the description herein may mention tracking or requesting a particular version of a data object, tracking or requesting a portion of a particular version of a data object may also be possible by specifying, in a request to be performed, the range of addresses associated with the data object that may be less than for the entire data object and which may correspond to a particular portion of interest of the data object version. Likewise, a particular start/base address and particular data object address range may be used to specify the particular version of a particular portion, whole, or more than one data object of interest. For purposes of ease of describing aspects of the present disclosure, details may be described using a data object level granularity level (e.g., a particular version of a data object may be of interest). Nevertheless, it is understood that the present disclosure may also be practiced at a data object portion or subpart level and/or at a more than one data object level for any version of respective data objects by specifying a particular start/base address and address range associated with a particular version of one or more particular data objects.

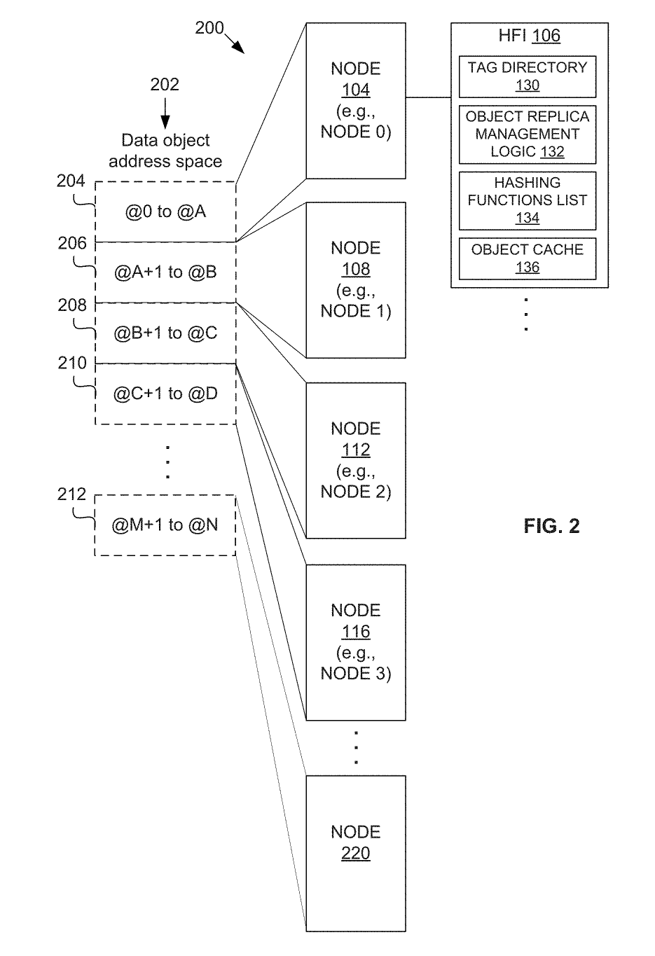

FIG. 2 illustrates an example depiction of mapping 200 between a data object address space 202 and the plurality of compute nodes included in the system 100, according to some embodiments. The data object address space 202 may range from an address 0 through N and may be divided into portions 204-212, in which each of the portions 204-212 may comprise a respective sub-range of the addresses between 0 and N. In some embodiments, portion 204 may comprise addresses 0 to A and map to compute node 104, portion 206 may comprise addresses A+1 to B and map to compute node 108, portion 208 may comprise addresses B+1 to C and map to compute node 112, portion 210 may comprise addresses C+1 to D and map to compute node 116, and so forth, up to portion 212 which may comprise addresses M+1 to N and map to compute node 220. Although not shown in FIG. 1, compute node 220 may also be included in the system 100. Addresses A to N may comprise memory lines of memory located in one or more of the compute nodes 104, 110, 112, 116, 220 and/or other memory or storage.

As described in detail below, when a data object is to be generated, the data object may be assigned a unique data object identifier (also referred to as an object identifier). A data object identifier may comprise an address of the data object address space 202, or a start or base address of the data object address space 202 and an address range, commiserate with the overall address locations of the associated data object. Mapping 200 may define a home node relationship between particular addresses of the data object address space 202 and respective compute nodes of the plurality of compute nodes of the system 100. In other words, portions 204, 206, 208, 210, 212 may be deemed to be “homed” to respective compute nodes 104, 108, 112, 116, 220. Because data object identifiers may be addresses of the data object address space 202, mapping 200 may also define which data objects may be “homed” to which compute node. Hence, in some embodiments, compute node 104 may comprise the home compute node for data objects assigned data object identifiers 0 to A, compute node 108 may comprise the home compute node for data objects assigned data object identifiers A+1 to B, compute node 112 may comprise the home compute node for data objects assigned data object identifiers B+1 to C, compute node 116 may comprise the home compute node for data objects assigned data object identifiers C+1 to D, and compute node 220 may comprise the home compute node for data objects assigned data object identifiers M+1 to N. Mapping 100 may be defined prior to use of data objects within the system 100.

A home compute node (also referred to as a home node) may comprise the particular compute node which tracks and maintains complete information regarding versions of each data object (or one or more of a subpart of each data object, as discussed above) “homed” or mapped to such compute node as well as the compute nodes to which each of the mapped data object may have been provided or shared (such compute nodes may be referred to as “sharers” or sharer compute nodes). One or more of the compute nodes other than the home compute node may also contain data object version information and/or sharer information, but such information may be incomplete, outdated, or otherwise not relied upon at least for fulfilling data object requests made by compute nodes, as described in detail below.

A home compute node or home node may generally refer to a particular compute node and/or its associated components (e.g., associated compute node interface), and not necessarily a compute node. In embodiments, the compute node interface associated with the particular compute node identified as a home compute node may perform the tracking and maintenance of version and sharer information regarding the homed data objects. The tag directory included in the compute node interface associated with the particular compute node may be configured to maintain such data object information, as described in detail below. For example, when compute node 104 is deemed to be a home compute node, compute node interface 106, and in particular, tag directory 130 included in compute node interface 106, may be configured to maintain version and sharer information about its mapped data objects.

In some embodiments, a particular home compute node and/or associated compute node interface may or may not store a data object mapped to the particular home compute node, all versions of a data object mapped to the particular home compute node, the particular version(s) of a data object mapped to the particular home compute node that may be requested by another compute node, or the latest version of the data object mapped to the particular home compute node. As described in detail below, one or more versions of a data object mapped to the particular home compute node may be stored in one or more of compute nodes and/or associated compute node interfaces other than the data object's home compute node. Hence, where each version of a particular data object may be stored in the system 100 may be distinct from which component included in the system 100 may be responsible for keeping track of such versions of the particular data object.

In some embodiments, compute node interface 106 may be configured to track versions and sharers of each of the data objects homed or mapped to the compute node 104 (e.g., data objects assigned to data object addresses 0 to A). The tracked information (also referred to as data object version location information) may be maintained in the tag directory 130 included in the compute node interface 106. Tag directory 130 may comprise a (cameable) data structure, table, or the like suitable for storing and looking up selective tracked information about the homed data objects. For each homed data object of compute node 104, one or more of the following information, without limitation, may be maintained: a valid bit (e.g., indicates whether the data object may exist or not or may otherwise be valid (“1”) or invalid (“0”)); a data object identifier; an address range associated with the data object; a creator or owner (e.g., the creator or owner compute node of the data object); sharers of the data object (e.g., the compute node(s) to which the data object has been provided or shared); sharers' data object versions (e.g., the version(s) of the data object provided to respective sharers); the current or latest (known) version of the data object; compute node currently storing the current/latest version of the data object; and the locally cached version of the data object in the compute node interface 106 (if any).

An example tag directory table may be as provided below.

| | Data | Address | | | | | | Locally |
|---|---|---|---|---|---|---|---|---|
| | object | range or | Creator | | Sharers' versions | Current/latest | Current/latest | Cached |
| Valid | identifier | size | or owner | Sharers | (respectively) | (known) version | version's node | version |
| 1 | @0x0100 | [@0x0120, | Node 1 | Nodes 2, 5, 6 | Versions 3, 2, 4 | Version 4 | Nodes 1, 6 | Version 4 |
| | | 0x0150] | | | | | | |
| . . . | . . . | . . . | . . . | . . . | . . . | . . . | . . . | . . . |
| . . . | . . . | . . . | . . . | . . . | . . . | . . . | . . . | . . . |

In some embodiments, at least the current/latest version's node field of the above table may identify particular compute nodes, although the actual component in which the current/latest version of the data object is stored may be the particular compute node and/or the compute node interface associated with the particular compute node. Whether the particular compute node and/or the associated compute node interface identified in the table directory table possesses the version of interest may be determined by the associated compute node using information included in the object cache.

The object replica management logic 132 (also referred to as logic) included in the compute node interface 106 may be configured to perform, facilitate, or control implementation of embodiments of the scalable distributed data object management mechanism of the present disclosure. In some embodiments, the object replica management logic 132 may be configured to perform steering functions, in which when a requested version of a data object may not be available in compute node 104 or compute node interface 106, the request may be “steered,” redirected, or forwarded automatically to another compute node interface associated with a compute node that may be indicated as having the requested version of the data object based on information included in the tag directory 130 and/or hashing functions list 134, as described in detail below. A portion of the object replica management logic 132 (e.g., a home logic) may be used when the compute node interface 106 receives requests for data objects homed to compute node 104, and another portion of the object replica management logic 132 (e.g., a client logic) may be used when a software stack running in the compute node 104 may wish to request for a non-homed data object.

The hashing functions list 134 may be configured to discover and maintain the mapping 200. In some embodiments, at boot time associated with the system 100, the mapping 200 may be established and used until shut down of system 100. Mapping 200, which provides the division of addresses to compute nodes by a distributive hash, may also be referred to as hashing functions. The hashing functions list 134 may also be referred to as a system address decoder. The information included in the hashing functions list 134 may be referred to as mapping information or compute node-to-data object address mapping information.

The object cache 136 may comprise a cache, memory, or storage unit, such as a non-volatile memory (NVM), which may store certain of the data objects. For example, data objects incoming to the compute node 104, data objects requested by the compute node 104, data objects generated or created by the compute node 104, data objects repeatedly used by the compute node 104, latest versions of data objects homed to the compute node 104, portions thereof, and/or the like may be cached in the object cache 136. The caching function provided by the object cache 136 may permit the compute node interface 106 to automatically access one or more of the cached data objects for delivery to requestor/accessor compute nodes (e.g., compute node 104 and/or other compute node(s) of the system 100) without involvement of the compute node 104 (e.g., the software stack included in the compute node 104). Compute node 104 may be unaware that a data object request was made directly or via steering/redirection to itself if compute node interface 106 may be able to provide the data object from the object cache 136.

In addition to the values or content of the plurality of data objects cached in the object cache 136, the object cache 136 may also include metadata about each of the cached data objects. The metadata may comprise, without limitation, for each of the cached data objects/values: a data object identifier and the version cached. The metadata may also include other information such as a time date stamp of when the data object was cached and/or the size of the cache data object for each of the cached data objects. The metadata may be stored in a data structure, table, relational database, or the like that may be searched or selectively accessed to determine whether a particular version of a particular data object may be cached in the object cache 136, and thus available to be read out for delivery to a compute node.

In some embodiments, each time a new data object is to be cached and/or depending on the size or capacity of the object cache 136, eviction of one or more of the cached data objects may occur in order to adequately cache the new data object. The object cache 136 may comprise a caching structure that may be orthogonal or additional to other (e.g., traditional) memory hierarchies of the system 100. For instance, the data object address or memory lines assigned to a data object may be associated with the other or traditional memories, which may or may not be located in the compute node 104.

The above description of tag directory 130, object replica management logic 132, hashing functions list 134, and object cache 136 may also apply to respective components in each of the other compute node interfaces of the system 100 (e.g., compute node interfaces 110, 114, 118). In some embodiments, the content of each of the hashing functions lists 134, 144, 154, 164 may be identical to each other (e.g., the mapping 200). Object replica management logic 132, 142, 152, 162 may be similar or identical to each other. The content of tag directories 130, 140, 150, 160 may be different from each other since each directory may only contain information about its homed data objects. The content of object caches 136, 146, 156, 166 may also be different from each other.

In some embodiments, one or more of the tag directories 130, 140, 150, 160; object replica management logic 132, 142, 152, 162; hashing functions lists 134, 144, 154, 164; and/or the object caches 136, 146, 156, 166 may be implemented as firmware or hardware such as, but not limited to, an application specific integrated circuit (ASIC), programmable array logic (PAL), field programmable gate array (FPGA), circuitry, on-chip circuitry, on-chip memory, and the like. For example, at least the object replica management logic 132, 142, 152, 162 may comprise hardware based logic. Alternatively, one or more of the tag directories 130, 140, 150, 160; object replica management logic 132, 142, 152, 162; hashing functions lists 134, 144, 154, 164; and/or the object caches 136, 146, 156, 166 may be implemented as software comprising one or more instructions to be executed by one or more processors included in the same respective component with the one or more instructions or within the respective compute node interface 106, 110, 114, 118. In some embodiments, the one or more instructions may be stored and/or executed in a trusted execution environment (TEE) of the respective components. In some embodiments, the TEE may be included in a dedicated core of respective components.

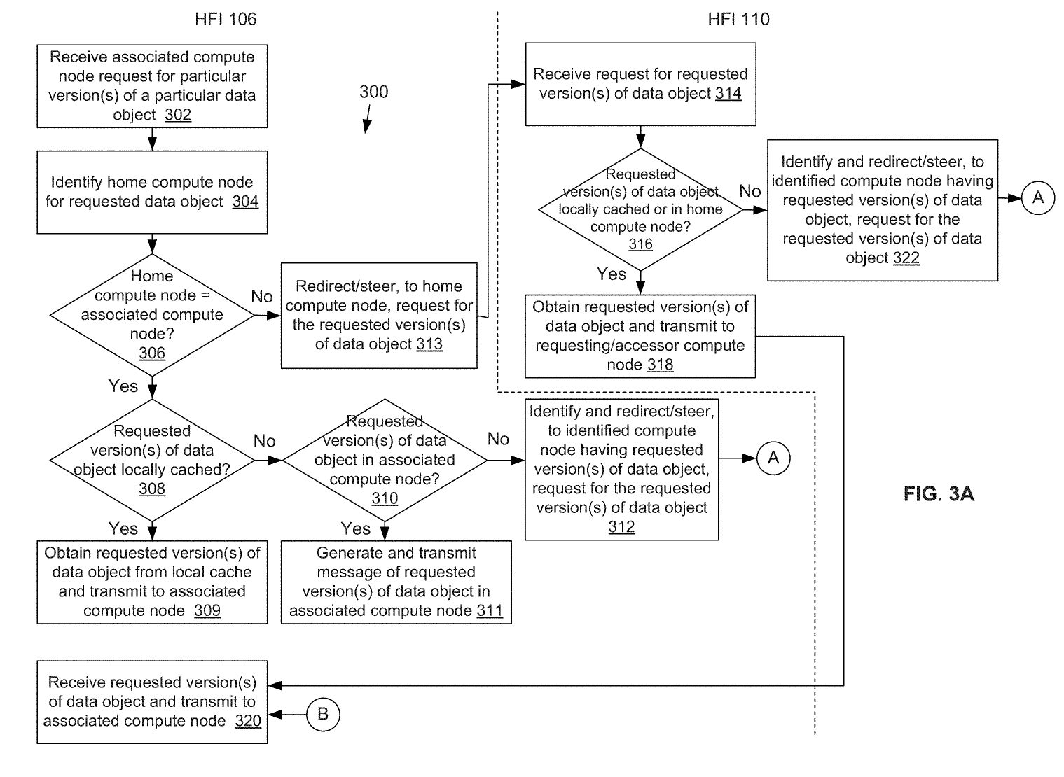

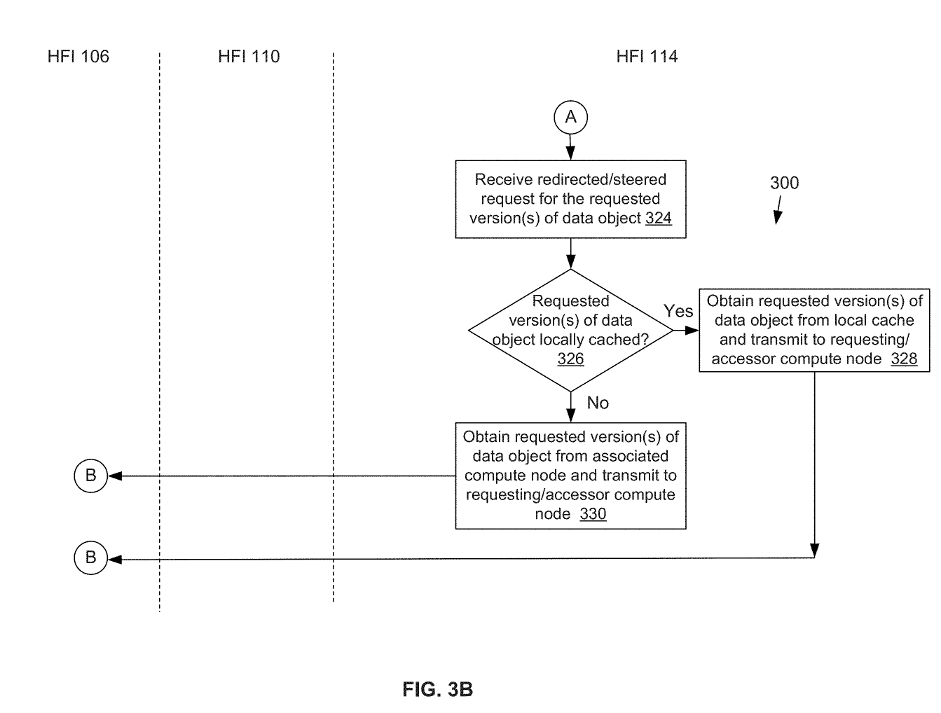

FIGS. 3A-3B depict an example process 300 to fulfill a request for a particular version of a particular data object made by a particular compute node included in the system 100 using the scalable distributed data object management mechanism, according to some embodiments. For purposes of illustration, assume that the particular compute node that makes the request may comprise the compute node 104.

In response to the request made by the compute node 104 (e.g., the software stack included in the compute node 104) for the particular version(s) of the particular data object, the request may be transmitted to and received by the compute node interface 106, at a block 302. The requested version of the data object may comprise one or more versions and may be specified in any number of ways including, but not limited to, a particular version identifier (such as a version number), the latest version, the earliest or first version, the last two versions, versions 2-5, or the like. The particular data object may be specified by its data object identifier.

Next, at a block 304, the object replica management logic 132 included in the compute node interface 106 may be configured to determine which compute node may be the home compute node for the data object of interest in the request. The object replica management logic 132 may access the hashing functions list 134 to look up the mapping information for the data object of interest.

When compute node 104, the compute node associated with the compute node interface 106, comprises the home compute node for the data object of interest (yes branch of block 306), then process 300 may proceed to block 308. Otherwise, a compute node other than compute node 104 may be the home compute node for the data object of interest (no branch of block 306) and process 300 may proceed to block 313.

At the block 308, the object replica management logic 132 may be configured to determine whether the requested version of interest may be locally cached in the object cache 136. Data object metadata maintained in the object cache 136 may be accessed to identify the presence of the requested version of interest in the object cache 136. If the requested version is locally cached (yes branch of block 308), then the object replica management logic 132 may be configured to read or obtain the value of the requested version of interest from the object cache 136 and transmit/deliver the value to the compute node 104, at a block 309. In this case, the home compute node and the store compute node (or associated compute node interface) may be the same.

Otherwise the requested version of interest may not be locally cached in the object cache 136 (no branch of block 308), and process 300 may proceed to block 310. In some embodiments, the object replica management logic 132 may be configured to access the tag directory 130 to determine whether the requested version of interest may be located in the compute node 104, at the block 310. When the determination may be affirmative (yes branch of block 310), then process 300 may proceed to block 311. For example, if the requested version of interest comprises the latest version of the particular data object and the tag directory 130 indicates that the latest version of the particular data object is located in the compute node 104, since the object cache 136 also indicates that the latest version of the particular data object is not locally cached (see inquiry of block 308), the compute node 104 specified in the tag directory 130 may actually refer to the compute node 104 rather than the compute node interface 106. Accordingly, the object replica management logic 132 may be configured to generate and transmit a message to the compute node 104, in a block 311, providing a reply to the request indicating that the version of interest specified in the compute node 104's original request may be found within the compute node 104. Such message, for example, may serve as a confirmation to the compute node 104 that one or more versions of the data object of interest already stored in the compute node 104 may be the version of interest. Continuing the example, the message may serve as confirmation that the version of the particular data object already in possession by the compute node 104 comprises the latest version, the version of interest.

When the object replica management logic 132 determines that the requested version of interest may not be located in the compute node 104 (no branch of block 310), then the requested version of interest may not be located in the compute node interface 106 nor the compute node 104. Hence, the request may be steered or redirected to another compute node in order to be fulfilled, at a block 312. At the block 312, the object replica management logic 132 may be configured to look up the contents of the tag directory 130, since this tag directory comprises the “home” tag directory for the data object of interest, to identify the particular compute node listed as having the requested version of the data object. The request may thus be redirected or steered to this particular compute node in possession of the requested version of the data object, also referred to as the identified compute node. The redirected/steered request may be the same as the original request received in block 302 or may be modified, appended, or otherwise made suitable for the identified compute node to respond to the request.

Although the identified compute node may comprise any one of the compute nodes 108, 112, 116, 220 in accordance with the tag directory 130, for purposes of illustration, the identified compute node may be assumed to be compute node 112. The request of block 312 may be received by the compute node interface 114 associated with the identified compute node 112 at a block 324.

Returning to block 306, when the home compute node for the data object of interest is not the compute node 104 according to the hashing functions list 134 (no branch of block 306), the object replica management logic 132 may be configured to redirect or steer the request to the home compute node at a block 313. As discussed above, the home compute node, and in particular, the tag directory included in the compute node interface associated with the home compute node may be tasked with tracking and maintaining information about where versions of the data object of interest may be located. Thus, the request may be steered to the appropriate compute node known to possess the needed version location information. The redirected/steered request may be the same as the original request received in block 302 or may be modified, appended, or otherwise made suitable for the home compute node to respond to the request.

Although the home compute node may comprise any one of the compute nodes 108, 112, 116, 220 in accordance with the hashing functions list 134, for purposes of illustration, the home compute node may be assumed to be compute node 108. The request of block 313 may be received by the compute node interface 110 associated with the home compute node 108 at a block 314.

Next, at a block 316, the object replica management logic 142 included in the home compute node interface 110 may be configured to access the tag directory 140 to determine which compute node(s) may have a copy of the requested version of the data object of interest. If the tag directory 140 indicates that the requested version of the data object of interest may be located in the compute node 108 (e.g., the home compute node for the data object of interest) (yes branch of block 316), then process 300 may proceed to block 318. The tag directory 140 may also indicate whether the requested version of interest may be locally cached in the compute node interface 110. If the requested version of interest may be cached in the object cache 146, then the value may be obtained from the object cache 146 and transmitted to the requesting or accessor compute node (e.g., compute node interface 106) at a block 318. If the requested version of interest may not be cached in the object cache 146, then the requested version of interest may be obtained from the (traditional) memory or disk included in the home compute node 108 and transmitted to the requesting or accessor compute node (e.g., compute node interface 106) at the block 318. In this case, the requested version of the data object of interest may be tracked and located in the home compute node (or associated home compute node interface) of the data object of interest.

The value or content of the requested version of the data object of interest may be transmitted in block 318 to be received by the compute node interface 106 at a block 320. At the block 320, the compute node interface 106 may transmit the received value or content to the compute node 106, thereby fulfilling or being fully responsive to the original request received at the block 302.

Returning to block 316, if the tag directory 140 indicates that the requested version of the data object of interest may not be located in the compute node 108 (and by extension, also not located in the compute node interface 110) (e.g., the absence of an entry for the compute node 108 as a node having the requested version), then process 300 may proceed to block 322. The tag directory 140 may also indicate the particular compute node storing the requested version of the data object of interest, the identified compute node. At the block 322, the object replica management logic 142 may be configured to identify the particular compute node storing the requested version of the data object of interest based on the tag directory 140. And the request may be redirected or steered to the identified compute node. The redirected/steered request may be the same as the original request received in block 302 or the steered request received in block 314, or may be modified, appended, or otherwise made suitable for the identified compute node to respond to the request.

Although the identified compute node may comprise any one of the compute nodes 104, 112, 116, 220 in accordance with the tag directory 140, for purposes of illustration, the identified compute node may be assumed to be compute node 112. The request sent in block 322 may be received by the compute node interface 114 associated with the identified compute node 112 at a block 324.

Next, at the block 326, the object replica management logic 152 included in the compute node interface 114 may be configured to determine whether the requested version may be locally cached in the object cache 156 based on at least data object metadata information included in the object cache 156. If locally cached, then the request may be fulfilled without involvement of the compute node 112. Compute node 112 may not even be aware of the incoming request for the data object. If the requested version may be present in the object cache 156 (yes branch of block 326), then the object replica management logic 152 may obtain the value or content of the requested version from the object cache 156 and transmit the value/content to the requesting/accessor compute node, e.g., to compute node interface 106, at a block 328. The transmitted value/content may be received by the compute node interface 106 at the block 320.

Otherwise, if the requested version may not be present within the object cache 156 (no branch of block 326), then the object replica management logic 152 may obtain the value/content of the requested version of the data object of interest from a (traditional) memory or disk included in the compute node 112 and transmit the value/content to the requesting/accessor compute node, at a block 330. The transmitted value/content may be received by the compute node interface 106 at the block 320.

In this manner, the identified compute node 112 may fulfill the request for the particular version of a particular data object made by the compute node 104 via the compute node 108.

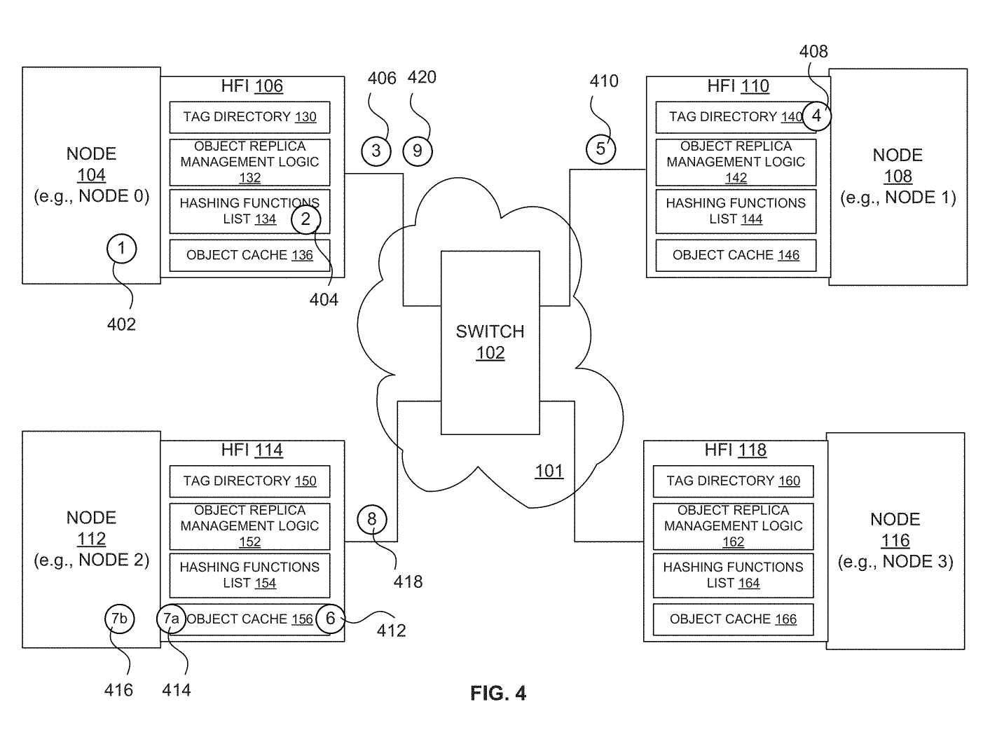

FIG. 4 depicts an example illustration showing a pathway followed among components of the system 100 in order to fulfill a request for a particular version of a particular data object in accordance with the process 300 of FIGS. 3A-3B, according to some embodiments. At a first time point 402, the compute node 104 may make a request for the latest version of a data object 2. In response, at a second time point 404, the compute node interface 106 may access the hashing functions list 134 which may identify compute node 108 as the home compute node for data object 2. Accordingly, the request may be redirected, steered, or forwarded to home compute node 108, at a third time point 406.

The steered request may be delivered to the compute node interface 110 via the switch 102. At a fourth time point 408, the compute node interface 110 may determine, from the tag directory 140, that its locally cached version of data object 2 is version 3 while the latest version of data object 2 is version 6, and that the latest version 6 may be available at compute node 112. Based on the information in the tag directory 140, the request may again be redirected, steered, or forwarded to compute node 112 identified to have the latest version 6 of data object 2, at a fifth time point 410.

The steered request may then be delivered to the compute node interface 114 via the switch 102. At a sixth time point 412, the compute node interface 114 may be configured to determine, from the object cache 156, whether the version 6 of data object 2 may be locally cached or in compute node 112. If version 6 of data object 2 may be present in the object cache 156, then the value or content of version 6 of data object 2 may be read from the object cache 156 at a seventh time point 414. If version 6 of data object 2 may not be present in the object cache 156, then the value or content of version 6 of data object 2 may be obtained from the (traditional) memory or disk included in the compute node 112, at a seventh time point 416.

Then, at an eighth time point 418, the obtained value/content of version 6 of the data object 2—the requested version of the data object—may be transmitted to the requesting/accessor compute node 104, and delivered to the compute node interface 106 via the switch 102, at a ninth time point 420.

In some embodiments, the concept of PUT or WRITE for a given data object may be absent in embodiments of the scalable distributed data object management mechanism of the present disclosure. The mechanism may comprise an active demand scheme. Thus, data objects may be updated locally, and changes to the data objects may be notified to the respective home compute nodes (and peer or sharer compute nodes, if required). The sharers of a given data object may pull or obtain the latest version of the data object, as needed. Embodiments of the scalable distributed data object management mechanism may provide granular level tracking and management of data objects, such as tracking the data objects at an address range granularity or at byte addressable levels, which may be too costly and/or resource intensive for software based schemes.

In some embodiments, compute node architecture may be extended or modified to expose or implement functionalities of the distributed management mechanism. Without limitation, the software stack included in each of the compute nodes may use an application program interface (API) to appropriately communicate with respective associated compute node interfaces to facilitate implementation of the mechanism. The fabric transport layer (L4) may be extended, in some embodiments, in connection with implementation of embodiments of the mechanism.

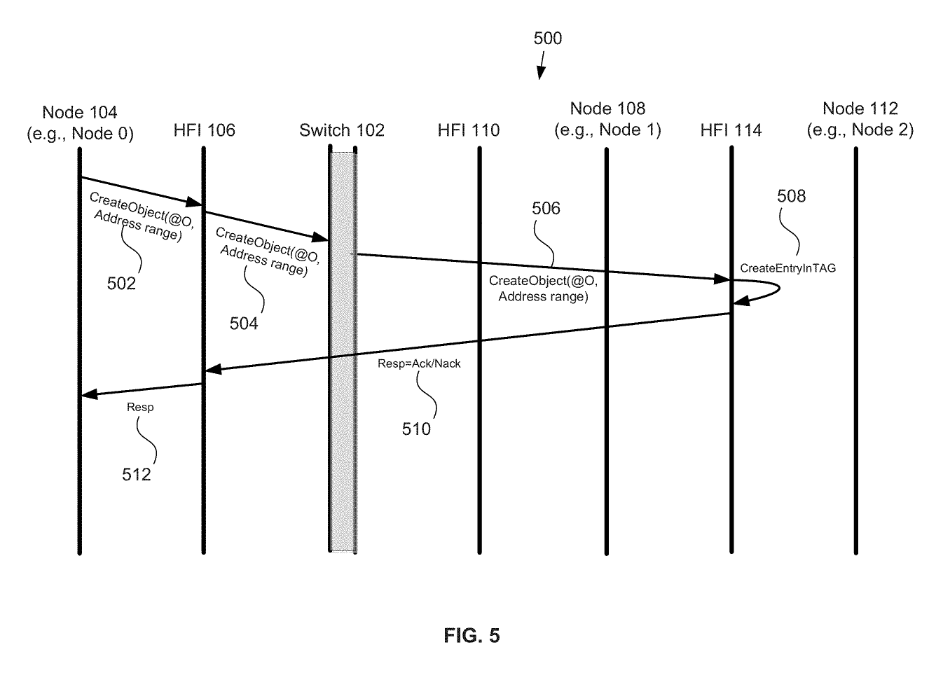

Additional aspects of embodiments of the mechanism are described below in connection with FIGS. 5-11. FIG. 5 depicts a diagram illustrating an example process 500 for data object creation within the system 100, according to some embodiments. Assume that compute node 104 wishes to create a new data object. Compute node 104 may be configured to generate a CreateObject request, which may include, without limitation, a particular start or base address to be assigned or associated with the new data object to be created (e.g., @O) and an address range associated with the successive address locations in which the rest of the new data object is to be located (e.g., Address range), as shown in item 502. The CreateObject request may be transmitted from the compute node 104 to its associated compute node interface 106, as shown in item 504.

The compute node interface 106 may perform a look up of the home compute node for the new data object to be created using the particular start/base address specified in the CreateObject request and the mapping information maintained in the hashing functions list 134. Assume that compute node 112 is identified as the home compute node. Hence, the compute node interface 106 may transmit the CreateObject request to the compute node interface 114 associated with the home compute node 112 via the switch 102, at item 506.

In response to receipt of the CreateObject request at the (home) compute node interface 114, a new data object entry corresponding to the CreateObject request may be created in the tag directory 150 included in the compute node interface 114, as shown in item 508. The creation of a new data object entry may also automatically trigger tracking of versions and storage locations of the data object (and other possible information about the data object) by its home compute node interface 114. Note that the home compute node 112 may not be involved and/or even be aware that creation of a data object mapped to itself may be occurring.

After successful creation of the data object entry, compute node interface 114 may generate an Acknowledgement response (ACK), or if creation may be unsuccessful, a Non-acknowledgement response (NACK) or no response may be generated, to the compute node interface 106 via the switch 102, at item 510. In turn, the compute node interface 106 may notify the compute node 104 of whether the request has been completed (e.g., forward the response), at item 512.

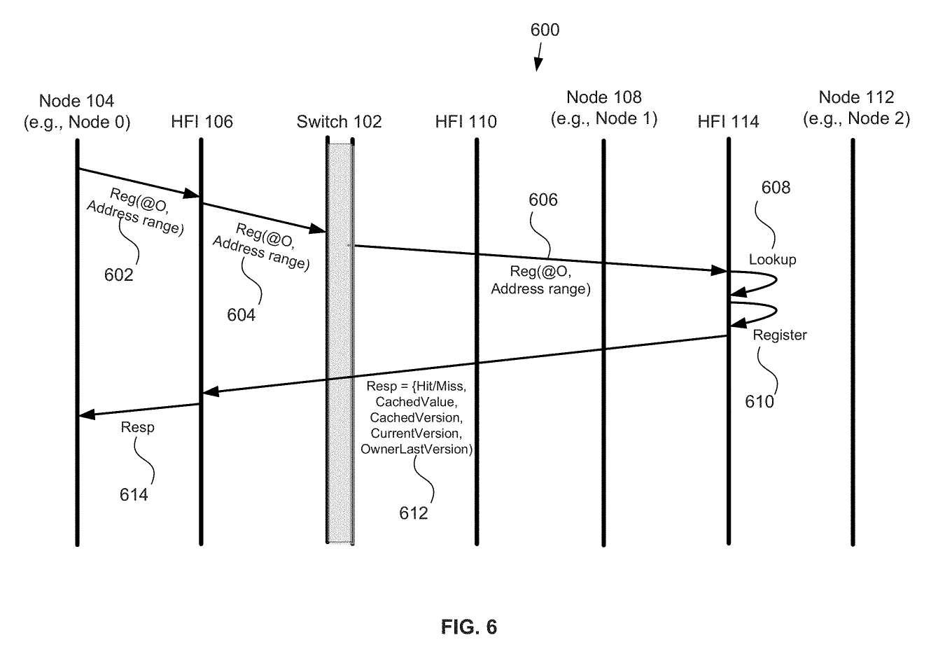

FIG. 6 depicts a diagram illustrating an example process 600 for registering a data object in the system 100, according to some embodiments. A compute node may register a new version of a data object (or portion(s) thereof) to the data object's home compute node. When more than one compute node generates respective new versions of a data object (or portion(s) thereof), each of these compute nodes may register its respective new version with the data object's home compute node. After registration, the new version of the data object may be tracked and managed by the data object's home compute node. Registration may be considered to be self-reporting to the data object's home compute node of the new version and/or trigger for the data object's home compute node to track the new version henceforth. In some embodiments, data object creation (FIG. 5) may be followed by registration of a given data object.

The compute node 104 may initiate registration of a particular data object by generating a registration (Reg) request, which may include, without limitation, a particular start address of the data object to be registered (e.g., @O) and an address range associated with the successive address locations in which the rest of the data object may be stored (e.g., Address range), as shown in item 602. In some embodiments, the same compute node that creates the particular data object may also initiate registration of the particular data object. The Reg request may be transmitted from the compute node 104 to its associated compute node interface 106, as shown in item 604.

The compute node interface 106 may perform a look up of the home compute node for the data object using the particular start address specified in the Reg request and the mapping information maintained in the hashing functions list 134. Assume that compute node 112 is identified as the home compute node. The compute node interface 106 may transmit the Reg request to the compute node interface 114 associated with the home compute node 112 via the switch 102, at item 606.

Upon receiving the Reg request, the compute node interface 114 may perform a lookup of the particular data object in the tag directory 150, at item 608. Compute node interface 114 may note the registration, such as by setting a registration flag within the tag directory 150, at item 610. Using information included in at least the tag directory 150, the compute node interface 114 may generate a response message (Resp), at item 612. The response message may include one or more of, without limitation: a hit or miss indication (e.g., hit if an entry exists for the particular data object or miss if no entry exists for the particular data object), the locally cached value, the version of the locally cached value, the current or latest version number of the particular data object, which compute node owns or has a copy of the latest version, and the like. The response message may be transmitted to the compute node interface 106 via the switch 102.

In turn, the compute node interface 106 may notify the compute node 104 of whether the request has been completed (e.g., forward the response), at item 614.

As an example, assume that an application may be running in the compute node 104, and the application desires to modify 10 Megabytes (MB) from interval MB 1 to MB 11 of a document “text.doc.” The application may thus initiate generation of a request to register this interval to the home compute node of the document “text.doc” (e.g., the data object). Assume that the home compute node may be compute node 112. The registration request may comprise, for example, Reg(@text.doc, [1-11 MB]). Then as shown in FIG. 6, home compute node 112 may return a response that includes tracked information about the interval of interest.

By requesting registration, compute node 104 may be able to discover, from the home compute node, if some other compute node(s) already have the interval of interest. During registration, if the home compute node 112 notices, from the information included in the tag directory 150, that the interval of interest may be divided into two sub-parts that are shared by two different compute nodes—for instance, [MB 1 to MB 5] shared by node X and [MB 6 to MB 8] shared by node Y, then the home compute node 112 may register the requesting compute node (e.g., compute node 104) to each of these existing two sub-parts and create a new entry in the tag directory 150 for the portion of the interval of interest not yet shared by any other compute node. Accordingly, after completion of registration of interval [MB 1 to MB 10], the following information may be reflected in the tag directory 150:

[MB 1 to MB 5] now shared by node X and compute node 104

[MB 6 to MB 8] now shared by node Y and compute node 104

[MB 9 to MB 10] shared by only compute node 104.

The above information may comprise what is returned to compute node 104 upon completion of registration.

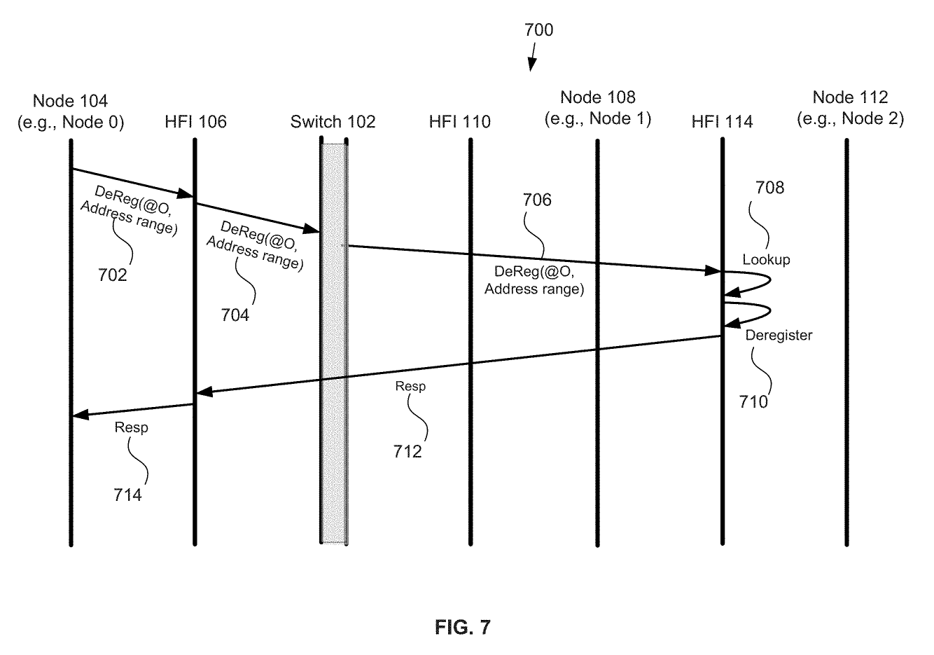

FIG. 7 depicts a diagram illustrating an example process 700 for deregistering a data object in the system 100, according to some embodiments. A compute node may de-register a particular version of a data object (or portion(s) thereof) to the data object's home compute node. Continuing the example above, if compute node 104 were to de-register the same interval [MB 1 to MB 10] just registered, de-registration may comprise removing compute node 104 as a sharer in each of the three sub-parts of the interval. In some embodiments, de-registration of a data object may occur at a later point in time than registration of the same data object.

The compute node 104 may initiate de-registration of a particular data object by generating a de-registration (DeReg) request, which may include, without limitation, a particular start address of the data object to be deregistered (e.g., @O) and an address range associated with the successive address locations in which the rest of the data object may be stored (e.g., Address range), as shown in item 702. In some embodiments, the same compute node that registered access to the particular data object may also initiate de-registration of the particular data object. The DeReg request may be transmitted from the compute node 104 to its associated compute node interface 106, as shown in item 704.

The compute node interface 106 may perform a look up of the home compute node for the data object using the particular start address specified in the DeReg request and the mapping information maintained in the hashing functions list 134. Assume that compute node 112 is identified as the home compute node. The compute node interface 106 may transmit the DeReg request to the compute node interface 114 associated with the home compute node 112 via the switch 102, at item 706.

Upon receiving the DeReg request, the compute node interface 114 may perform a lookup of the particular data object in the tag directory 150, at item 708. Compute node interface 114 may note the de-registration, such as by changing the registration flag within the tag directory 150, at item 710. The compute node interface 114 may generate a response message (Resp), at item 712, to acknowledge confirmation of the de-registration. The response message may be transmitted to the compute node interface 106 via the switch 102.

In turn, the compute node interface 106 may notify the compute node 104 of whether the request has been completed (e.g., forward the response), at item 714.

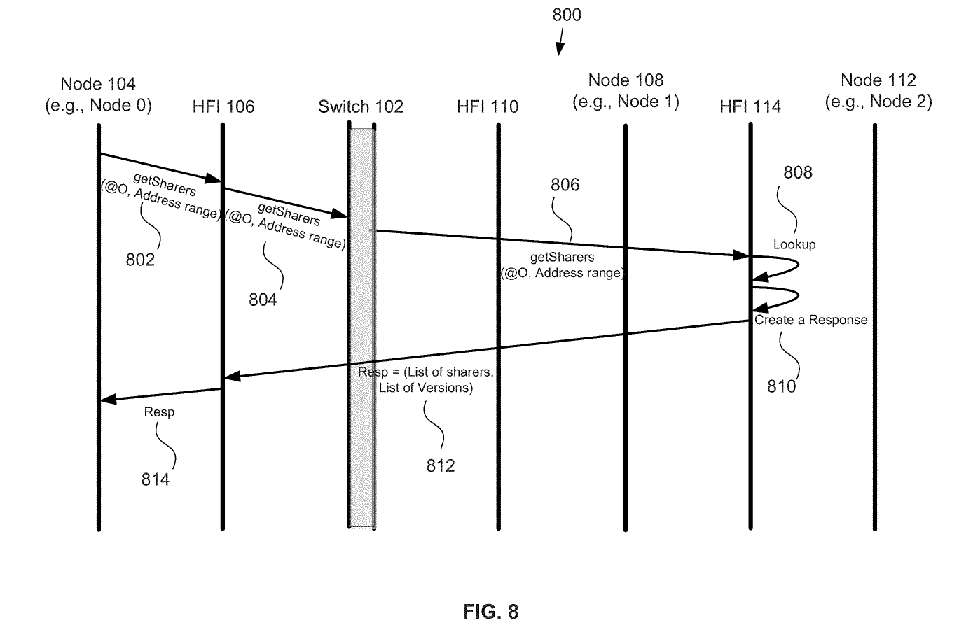

FIG. 8 depicts a diagram illustrating an example process 800 to obtain a list of sharers of a particular data object and the known versions of the particular data object held by the respective sharers, according to some embodiments.

The compute node 104 may generate a getSharers request, which may include, without limitation, a particular start address of the data object for which sharer information is being requested (e.g., @O) and an address range associated with the successive address locations in which the rest of the data object may be stored (e.g., Address range), as shown in item 802. The getSharers request may be transmitted from the compute node 104 to its associated compute node interface 106, as shown in item 804.

The compute node interface 106 may perform a look up of the home compute node for the data object using the particular start address specified in the getSharers request and the mapping information maintained in the hashing functions list 134. Assume that compute node 112 is identified as the home compute node. The compute node interface 106 may transmit the getSharers request to the compute node interface 114 associated with the home compute node 112 via the switch 102, at item 806.

Upon receiving the getSharers request, the compute node interface 114 may perform a lookup of the particular data object's entry in the tag directory 150 to obtain a list of sharers and a list of version numbers associated with each of the sharers, at item 808. The obtained lists may be used to generate a response, at item 810. The response Resp may include, without limitation, a list of the sharers and a list of the version number(s) associated with each of the listed sharers. The response Resp may be transmitted from the compute node interface 114 to the compute node interface 106 via the switch 102, at item 812.

In turn, the compute node interface 106 may notify the compute node 104 of whether the request has been completed (e.g., forward the response), at item 814.

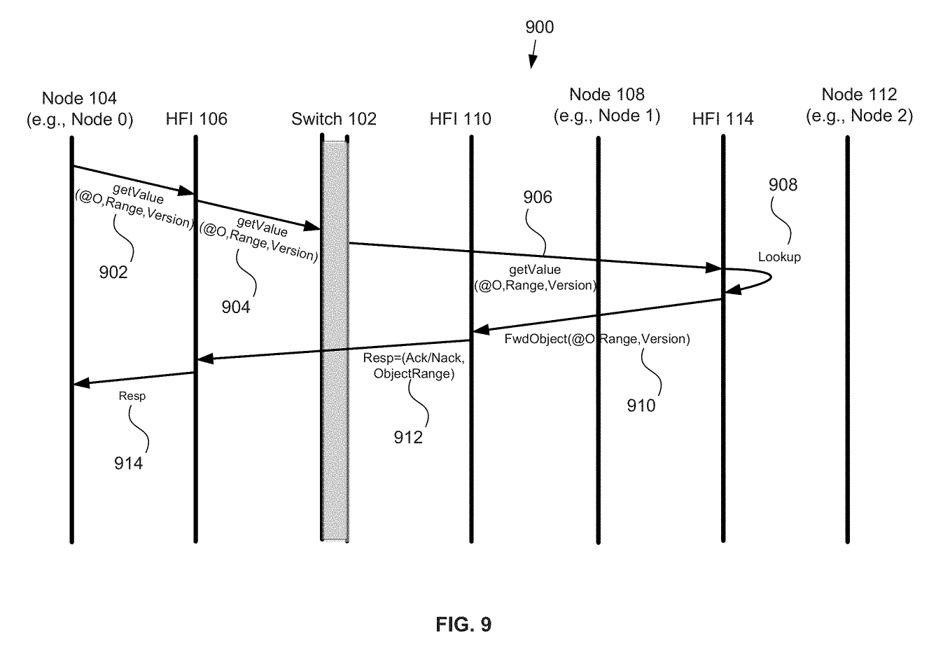

FIG. 9 depicts a diagram illustrating an example process 900 to obtain the value or content of a particular version of a particular data object, according to some embodiments. In some embodiments, process 800 may be performed to determine what versions may exist for the particular data object, and from that information, the compute node may decide which particular version of the known versions to request in the process 900.

The compute node 104 may be configured to generate a getValue request, which may include, without limitation, a particular start address of the data object of interest (e.g., @O), an address range associated with the successive address locations in which the rest of the data object of interest is located (e.g., Range), and the particular version of the data object of interest (e.g., Version), as shown in item 902. The getValue request may be transmitted from the compute node 104 to its associated compute node interface 106, as shown in item 904.

The compute node interface 106 may perform a look up of the home compute node for the data object of interest using the particular start address specified in the getValue request and the mapping information maintained in the hashing functions list 134. Assume that compute node 112 is identified as the home compute node. The compute node interface 106 may transmit the getValue request to the compute node interface 114 associated with the home compute node 112 via the switch 102, at item 906.

In response to receipt of the getValue request at the (home) compute node interface 114, the compute node interface 114 may be configured to perform a look up of the data object of interest in at least the tag directory 150, as shown in item 908. The look up may be performed to determine where the requested version of the data object of interest may be located. In FIG. 9, the look up may reveal that the requested version may not be present in the home compute node 112 nor the home compute node interface 114. Accordingly, the request may be redirected, steered, or forwarded to compute node interface 110, the compute node identified in the look up as having the requested version, at item 910. The forwarded request may be referred to as a FwdObject message or request, containing at least the same information as in the original request.

If the identified compute node 108 or its associated compute node interface 110 has the requested version of the data object, then the compute node interface 110 may generate a response Resp which may include an acknowledgement or confirmation of the request and the value or content of the requested version of the data object. If the requested version of the data object may not be available at the identified compute node 108 or its associated compute node interface 110, then the compute node interface 110 may generate a response Resp which may include a non-acknowledgement message to indicate failure to obtain the requested version of the data object or no response may be generated. In any case, the response Resp may be transmitted from the compute node interface 110 to compute node interface 106, at item 912. In response, the compute node interface 106 may notify the compute node 104 of whether the request has been completed (e.g., forward the response), at item 914.

Additional details regarding obtaining a particular version of a particular data object are discussed above in connection with FIGS. 3A-3B and 4.

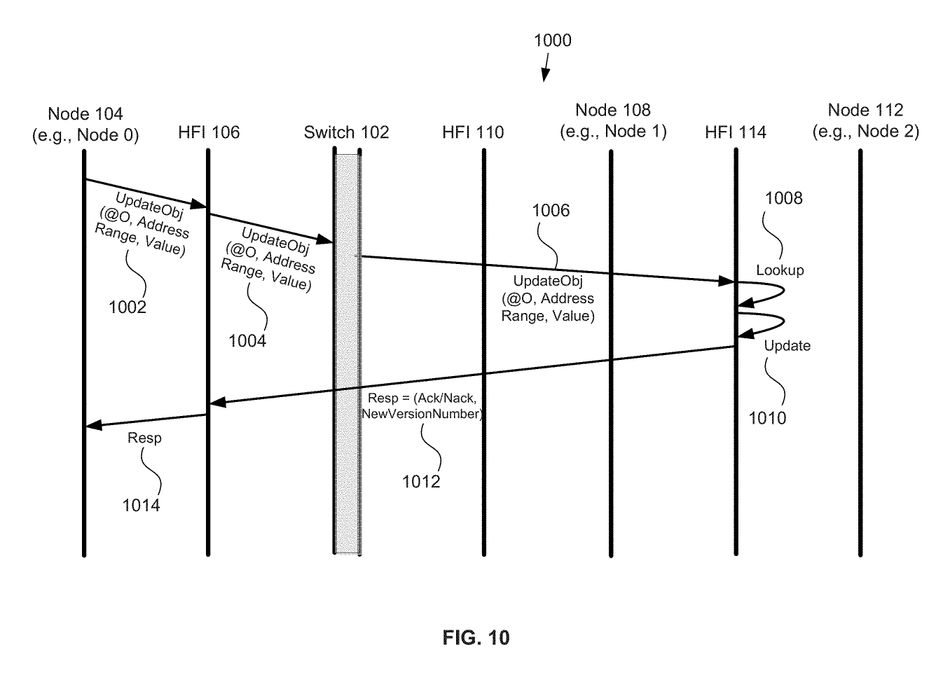

FIG. 10 depicts a diagram illustrating an example process 1000 for updating a data object, according to some embodiments. Updating a data object may comprise updating a value or content of the data object, and causing the data object with the update value/content be assigned with a new version number associated with the data object. As an example, a compute node that previously registered access to the data object to the data object's home compute node may update the value of the data object.

The compute node 104 may generate an update data object (UpdateObj) request, which may include, without limitation, a particular start address of the data object to be updated (e.g., @O), an address range associated with the successive address locations in which the rest of the data object may be stored (e.g., Address range), and a value or content to be updated to (e.g., Value), as shown in item 1002. The UpdateObj request may be transmitted from the compute node 104 to its associated compute node interface 106, as shown in item 1004.

The compute node interface 106 may perform a look up of the home compute node for the data object using the particular start address specified in the UpdateObj request and the mapping information maintained in the hashing functions list 134. Assume that compute node 112 is identified as the home compute node. The compute node interface 106 may transmit the UpdateObj request to the compute node interface 114 associated with the home compute node 112 via the switch 102, at item 1006.

Upon receiving the UpdateObj request, the compute node interface 114 may perform a lookup of the data object specified in the UpdateObj request in the tag directory 150, at item 1008. The current or latest version number included in the entry for the data object may be accessed, for example, so that the compute node interface 114 may know what new version number (e.g., a number incremented from the current/latest version number) to assign to the provided value. In some embodiments, the compute node interface 114 may locally cache the provided value in the object cache 156, update the tag directory 150 with the new version number being the current/latest version number, and update the tag directory 150 to indicate that the locally cached version is the new version, at item 1010.

Compute node interface 114 may generate a response (Resp) message, which may include, without limitation, an acknowledgement (Ack) and the new version number, upon completion of the update operation. Conversely, if the update is unsuccessful, compute node interface 114 may generate a Resp message that includes a non-acknowledgement (Nack) or no response may be generated. The Resp message may be transmitted from the compute node interface 114 to the compute node interface 106 via the switch 102, at item 1012. Lastly, the Resp message may be delivered from the compute node interface 106, which in turn may notify the compute node 104 of completion/incompletion of the update, at item 1014.

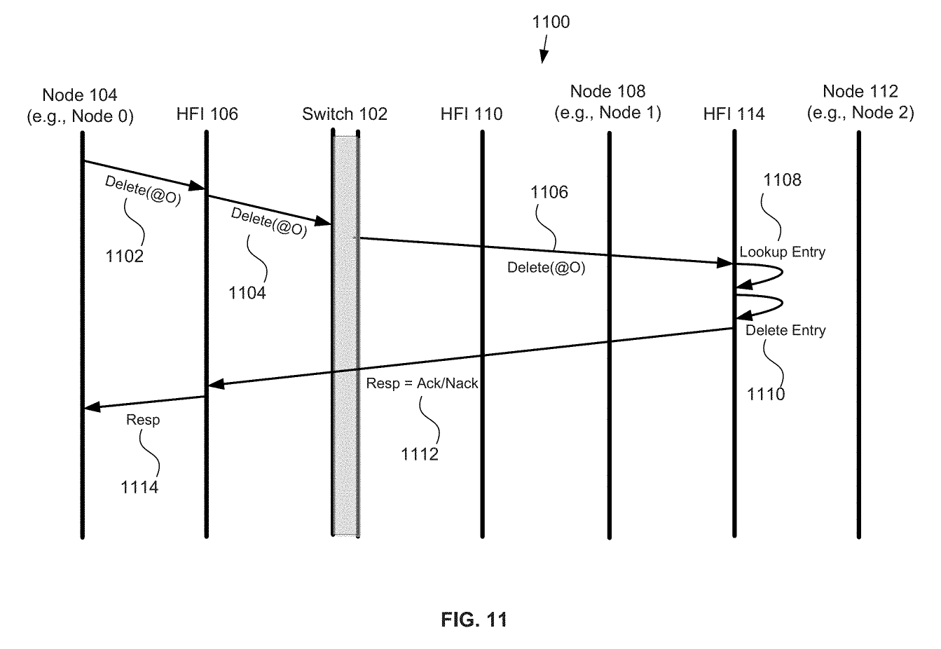

FIG. 11 depicts a diagram illustrating an example process 1100 for deleting a data object in the system 100, according to some embodiments. In some embodiments, deleting a data object may comprise deleting the entry maintained in the tag directory of the data object's home compute node interface. Such deletion may effectively delete or make invisible that data object within the system 100, even if one or more copies of the data object may still exist within the system 100. Since requests to access the data object may require a successful lookup in the data object's home tag directory, with the home tag directory no longer containing an entry for the data object, the location of the data object may be unknown, and access requests may not be fulfilled.

The compute node 104 may generate a delete data object (Delete) request, which may include, without limitation, a particular start address of the data object to be deleted, as shown in item 1102. The Delete request may be transmitted from the compute node 104 to its associated compute node interface 106, as shown in item 1104.

The compute node interface 106 may perform a look up of the home compute node for the data object using the particular start address specified in the Delete request and the mapping information maintained in the hashing functions list 134. Assume that compute node 112 is identified as the home compute node. The compute node interface 106 may transmit the Delete request to the compute node interface 114 associated with the home compute node 112 via the switch 102, at item 1106.

Upon receiving the Delete request, the compute node interface 114 may perform a lookup of the entry associated with the data object in the tag directory 150, at item 1108. The found entry may be deleted, at item 1110. Next, compute node interface 114 may generate a response (Resp) message, which may include, without limitation, an acknowledgement (Ack), upon completion of the deletion operation. Conversely, if the deletion is unsuccessful, compute node interface 114 may generate a Resp message that includes a non-acknowledgement (Nack) or no response may be generated. The Resp message may be transmitted from the compute node interface 114 to the compute node interface 106 via the switch 102, at item 1112. Lastly, the compute node interface 106 may notify the compute node 104 of the successful or unsuccessful completion of the requested deletion, at item 1114.

Notice that in processes 300, 500-1100, requests include a start/base address and address range, which as discussed above may provide a syntax or mechanism by which a portion of a version of a data object, a version of an entire data object, or a version of more than one data object may be specified to which the request pertains. As an alternative to specifying an address range, the corresponding size of the data object(s) or portion thereof of interest may be included in the requests. The size may range from one byte up to any arbitrary size.

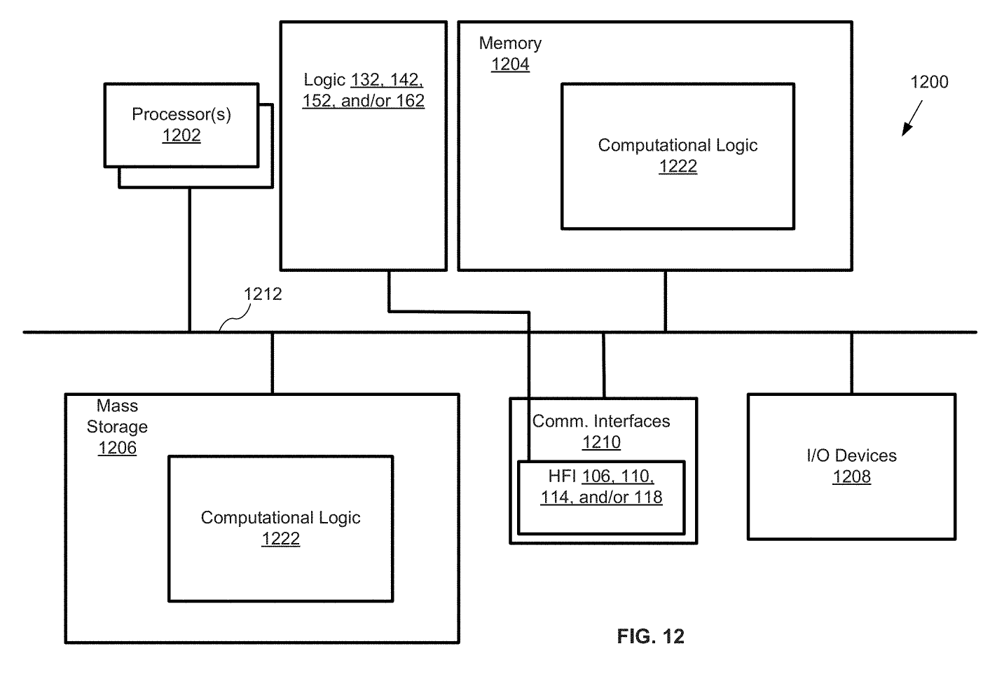

FIG. 12 illustrates an example computer device 1200 suitable for use to practice aspects of the present disclosure, in accordance with various embodiments. In some embodiments, computer device 1200 may comprise at least a portion of any of the switch 102, compute node 104, compute node 108, compute node 112, compute node 116, compute node 220, compute node interface 106, compute node interface 110, compute node interface 114, and/or compute node interface 118. As shown, computer device 1200 may include one or more processors 1202, and system memory 1204. The processor 1202 may include any type of processors. The processor 1202 may be implemented as an integrated circuit having a single core or multi-cores, e.g., a multi-core microprocessor. The computer device 1200 may include mass storage devices 1206 (such as diskette, hard drive, volatile memory (e.g., DRAM), compact disc read only memory (CD-ROM), digital versatile disk (DVD), flash memory, solid state memory, and so forth). In general, system memory 1204 and/or mass storage devices 1206 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computer device 1200 may further include input/output (I/O) devices 1208 such as a microphone, sensors, display, keyboard, cursor control, remote control, gaming controller, image capture device, and so forth and communication interfaces 1210 (such as network interface cards, modems, infrared receivers, radio receivers (e.g., Bluetooth)), antennas, and so forth.

The communication interfaces 1210 may include communication chips (not shown) that may be configured to operate the device 1200 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 1210 may operate in accordance with other wireless protocols in other embodiments. In embodiments, at least one of compute node interface 106, 110, 114, or 118 may be disposed in communication interfaces 1210.

The above-described computer device 1200 elements may be coupled to each other via a system bus 1212, which may represent one or more buses. In the case of multiple buses, they may be bridged by one or more bus bridges (not shown). Each of these elements may perform its conventional functions known in the art. In particular, system memory 1204 and mass storage devices 1206 may be employed to store a working copy and a permanent copy of the programming instructions to support the operations associated with system 100, e.g., in support of operations associated with one or more of logic 132, 142, 152, or 162 and/or one or more of compute node interface 106, 110, 114, or 118 as described above, generally shown as computational logic 1222. Computational logic 1222 may be implemented by assembler instructions supported by processor(s) 1202 or high-level languages that may be compiled into such instructions. The permanent copy of the programming instructions may be placed into mass storage devices 1206 in the factory, or in the field, through, for example, a distribution medium (not shown), such as a compact disc (CD), or through communication interfaces 1210 (from a distribution server (not shown)). In some embodiments, aspects of computational logic 1222 may be implemented in a hardware accelerator (e.g., Field Programmable Gate Arrays (FPGA)) integrated with, e.g., processor 1202, to accompany the central processing units (CPU) of processor 1202.

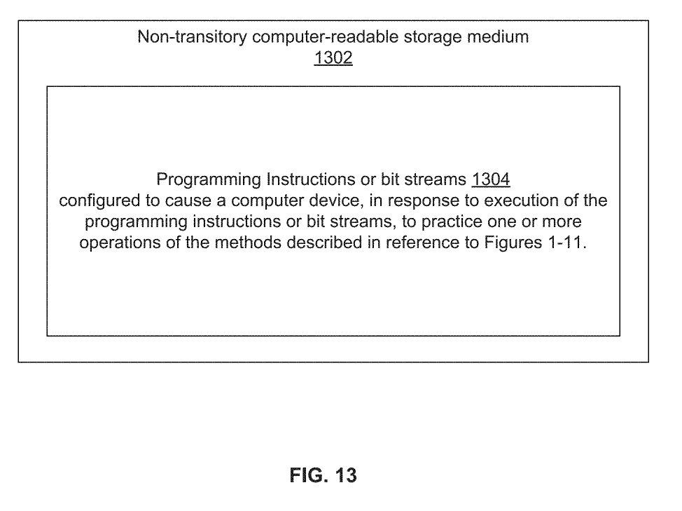

FIG. 13 illustrates an example non-transitory computer-readable storage media 1302 having instructions configured to practice all or selected ones of the operations associated with the processes described above. As illustrated, non-transitory computer-readable storage medium 1302 may include a number of programming instructions 1204 configured to implement one or more of logic 132, 142, 152, and/or 162, or computational logic 1222, or bit streams 1304 to configure the hardware accelerators to implement one or more of logic 132, 142, 152, and/or 162 or computational logic 1222. Programming instructions 1304 may be configured to enable a device, e.g., computer device 1200 (or HFI 106, 110, 114, or 118), in response to execution of the programming instructions, to perform (or in support of performance of) one or more operations of the processes described in reference to FIGS. 1-11. In alternate embodiments, programming instructions/bit streams 1304 may be disposed on multiple non-transitory computer-readable storage media 1302 instead. In still other embodiments, programming instructions/bit streams 1304 may be encoded in transitory computer-readable signals.

Referring again to FIG. 12, the number, capability, and/or capacity of the elements 1208, 1210, 1212 may vary, depending on whether computer device 1200 may be used as a compute node, a storage node, a I/O node, a switch, a gateway, a router, or the number of processes computer device 1200 is to support. Their constitutions are otherwise known, and accordingly will not be further described.

At least one of processors 1202 or HFI 106, 110, 114 or 118 may be packaged together with memory respectively having computational logic 1222 or logic 132, 142, 152, and/or 162 (or portion thereof) configured to support practice or practice aspects of embodiments described in reference to FIGS. 1-11. In some embodiments, at least one of the processors 1202 or HFI 106, 110, 114 or 118 (or portion thereof) may be packaged together with memory having respectively computational logic 1222 or logic 132, 142, 152, and/or 162 or aspects thereof configured to support the practice or practice aspects of processes 300, 500-1100 to form a System in Package (SiP) or a System on Chip (SoC).

In various implementations, the computer device 1200 may comprise a desktop computer, a server, a router, a switch, or a gateway. In further implementations, the computer device 1200 may be any other electronic device that processes data.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein.

Examples of the devices, systems, and/or methods of various embodiments are provided below. An embodiment of the devices, systems, and/or methods may include any one or more, and any combination of, the examples described below.

Example 1 is an apparatus including a first compute node interface to be communicatively coupled to a first compute node to receive a request from the first compute node for at least a portion of a particular version of a data object, wherein the first compute node interface is to include mapping information and logic, wherein the logic is to redirect the request to a second compute node interface associated with a second compute node when the second compute node is mapped to a plurality of data object addresses that includes an address associated with the data object in accordance with the mapping information, and wherein the first compute node is to receive, as a response to the request, the at least a portion of the particular version of the data object from a third compute node interface associated with a third compute node.

Example 2 may include the subject matter of Example 1, and may further include wherein the at least a portion of the particular version of the data object is stored in at least one of the third compute node or a data object cache included in the third compute node interface.

Example 3 may include the subject matter of any of Examples 1-2, and may further include wherein the third compute node interface is to provide the response when the at least a portion of the particular version of the data object is absent in the second compute node and the second compute node interface and the second compute node interface redirects the request to the third compute node interface based on data object version location information associated with the data object tracked and maintained in the second compute interface.

Example 4 may include the subject matter of any of Examples 1-3, and may further include wherein the first compute node interface includes a data object cache that stores the at least a portion of the particular version of the data object, wherein the logic is to retain the request in the first compute node interface when the first compute node is mapped to the address associated with the data object in accordance with the mapping information, and wherein the logic is to obtain, as the response to the request, the at least a portion of the particular version of the data object from the data object cache and to provide the response to the first compute node.

Example 5 may include the subject matter of any of Examples 1-4, and may further include wherein the data object comprises a file, a page, a document, a tuple, or a unit of data.

Example 6 may include the subject matter of any of Examples 1-5, and may further include wherein the logic comprises an application specific integrated circuit (ASIC), programmable array logic (PAL), field programmable gate array (FPGA), circuitry, on-chip circuitry, hardware, or firmware.

Example 7 may include the subject matter of any of Examples 1-6, and may further include wherein, when the first compute node is mapped to the plurality of data object addresses that includes the address associated with the data object in accordance with the mapping information, the first compute node interface includes first data object version location information associated with respective data objects of a plurality of data objects associated with the plurality of data object addresses mapped to the first compute node.

Example 8 may include the subject matter of any of Examples 1-7, and may further include wherein the first data object version location information includes, for each first data object of the plurality of data objects mapped to the first compute node, one or more of: a valid bit, a data object identifier, an address range associated with the first data object, a creator compute node of the first data object, sharers compute nodes to which the first data object was provided, identifiers of versions of the first data object provided to respective sharers compute nodes, an identifier of a latest version of the first data object, an identifier of a compute node currently storing the latest version of the first data object, or an identifier of a version of the first data object locally cached in the first compute node interface when locally cached in the first compute node interface.

Example 9 may include the subject matter of any of Examples 1-8, and may further include wherein the request includes a start address and an address range to specify the at least a portion of the particular version of the data object, and wherein the at least a portion of the particular version of the data object comprises a particular portion of a single data object, a single data object, or more than one data object.

Example 10 is a computerized method including receiving, at a first compute node interface associated with a first compute node of a plurality of compute nodes, a request from the first compute node for at least a portion of a particular version of a data object; in response to receipt of the request, determining whether a second compute node of the plurality of compute nodes is mapped to a plurality of data object addresses that includes an address associated with the data object based on mapping information between the plurality of compute nodes and the plurality of data object addresses; when the determination is affirmative, redirecting the request to a second compute node interface associated with the second compute node; receiving, from a third compute node interface associated with a third compute node of the plurality of compute nodes, a response to the request comprising the at least a portion of the particular version of the data object; and providing, to the first compute node, the response to the request.

Example 11 may include the subject matter of Example 10, and may further include wherein the at least a portion of the particular version of the data object is stored in at least one of the third compute node or a data object cache included in the third compute node interface.

Example 12 may include the subject matter of any of Examples 10-11, and may further include wherein receiving the response to the request from the third compute node interface comprises receiving the response to the request from the third compute node interface when the at least a portion of the particular version of the data object is absent in the second compute node and the second compute node interface and the second compute node interface redirected the request to the third compute node interface based on data object version location information associated with the data object tracked and maintained in the second compute interface.

Example 13 may include the subject matter of any of Examples 10-12, and may further include retaining the request, in the first compute node interface, when the first compute node is mapped to the address associated with the data object in accordance with the mapping information; and obtaining the at least a portion of the particular version of the data object from a data object cache included in the first compute node interface.

Example 14 may include the subject matter of any of Examples 10-13, and may further include wherein the data object comprises a file, a page, a document, a tuple, or a unit of data.

Example 15 may include the subject matter of any of Examples 10-14, and may further include wherein, when the first compute node is mapped to the plurality of data object addresses that includes the address associated with the data object in accordance with the mapping information, the first compute node interface includes first data object version location information associated with respective data objects of a plurality of data objects associated with the plurality of data object addresses mapped to the first compute node.

Example 16 may include the subject matter of any of Examples 10-15, and may further include wherein the first data object version location information includes, for each first data object of the plurality of data objects mapped to the first compute node, one or more of: a valid bit, a data object identifier, an address range associated with the first data object, a creator compute node of the first data object, sharers compute nodes to which the first data object was provided, identifiers of versions of the first data object provided to respective sharers compute nodes, an identifier of a latest version of the first data object, an identifier of a compute node currently storing the latest version of the first data object, or an identifier of a version of the first data object locally cached in the first compute node interface when locally cached in the first compute node interface.

Example 17 may include the subject matter of any of Examples 10-16, and may further include wherein the request includes a start address and an address range to specify the at least a portion of the particular version of the data object, and wherein the at least a portion of the particular version of the data object comprises a particular portion of a single data object, a single data object, or more than one data object.

Example 18 is a system including first, second, and third compute node interfaces communicatively coupled to each other; and first, second, and third compute nodes associated with and communicatively coupled to respective first, second, and third compute node interfaces, wherein the first compute node is to generate a request for at least a portion of a particular version of a data object, wherein the first compute node interface is to receive the request from the first compute node and to forward the request to the second compute node interface when the second compute node is mapped to a plurality of data object addresses that includes an address associated with the data object, and wherein the first compute node interface is to receive, as a response to the request, the at least a portion of the particular version of the data object from one of the second compute node interface or the third compute node interface.

Example 19 may include the subject matter of Example 18, and may further include wherein the second compute node interface is to provide the response to the first compute node interface when the at least a portion of the particular version of the data object is stored in at least one of the second compute node or a data object cache included in the second compute node interface.

Example 20 may include the subject matter of any of Examples 18-19, and may further include wherein the third compute node interface is to provide the response to the first compute node interface when the at least a portion of the particular version of the data object is absent in the second compute node and the second compute node interface and the second compute node interface redirects the request to the third compute node interface based on data object version location information associated with the data object tracked and maintained in the second compute interface.

Example 21 may include the subject matter of any of Examples 18-20, and may further include wherein the first compute node interface refrains from forwarding the request to the second compute node interface when the first compute node is mapped to the address associated with the data object, and wherein the at least a portion of the particular version of the data object is stored in a data object cache included in the first compute node interface and is to be obtained to be the response to the request.

Example 22 may include the subject matter of any of Examples 18-21, and may further include a switch, and wherein the first compute node interface is to receive the response from one of the second or third compute node interfaces via the switch, and wherein the first compute node interface is to provide the response to the first compute node.

Example 23 may include the subject matter of any of Examples 18-22, and may further include wherein, when the first compute node is mapped to the plurality of data object addresses that includes the address associated with the data object, the first compute node interface includes first data object version location information associated with respective data objects of a plurality of data objects associated with the plurality of data object addresses mapped to the first compute node.

Example 24 may include the subject matter of any of Examples 18-23, and may further include wherein the first data object version location information includes, for each first data object of the plurality of data objects mapped to the first compute node, one or more of: a valid bit, a data object identifier, an address range associated with the first data object, a creator compute node of the first data object, sharers compute nodes to which the first data object was provided, identifiers of versions of the first data object provided to respective sharers compute nodes, an identifier of a latest version of the first data object, an identifier of a compute node currently storing the latest version of the first data object, or an identifier of a version of the first data object locally cached in the first compute node interface when locally cached in the first compute node interface.

Example 25 may include the subject matter of any of Examples 18-24, and may further include wherein the request includes a start address and an address range to specify the at least a portion of the particular version of the data object, and wherein the at least a portion of the particular version of the data object comprises a particular portion of a single data object, a single data object, or more than one data object.

Example 26 is an apparatus including, in response to receipt of a request from a first compute node for at least a portion of a particular version of a data object, means for determining whether a second compute node of a plurality of compute nodes is mapped to a plurality of data object addresses that includes an address associated with the data object based on mapping information between the plurality of compute nodes and the plurality of data object addresses; when the determination is affirmative, means for redirecting the request to a second compute node interface associated with the second compute node; and means for receiving, from a third compute node interface associated with a third compute node of the plurality of compute nodes, a response to the request comprising the at least a portion of the particular version of the data object when the at least a portion of the particular version of the data object is absent in the second compute node and the second compute node interface and the second compute node interface redirected the request to the third compute node interface based on data object version location information associated with the data object tracked and maintained in the second compute interface.

Example 27 may include the subject matter of Example 26, and may further include means for retaining the request when a first compute node of the plurality of compute nodes is mapped to the address associated with the data object; means for locally obtaining the at least a portion of the particular version of the data object to be the response; and means for providing the response to the first compute node.

Example 28 may include the subject matter of any of Examples 26-27, and may further include wherein the at least a portion of the particular version of the data object is stored in at least one of the third compute node or a data object cache included in the third compute node interface.

Example 29 may include the subject matter of any of Examples 26-28, and may further include wherein the request includes a start address and an address range to specify the at least a portion of the particular version of the data object, and wherein the at least a portion of the particular version of the data object comprises a particular portion of a single data object, a single data object, or more than one data object.

Example 30 is one or more computer-readable storage medium comprising a plurality of instructions to cause a first compute node interface, in response to execution by one or more processors of the first compute node interface, to: receive, at the first compute node interface associated with a first compute node of a plurality of compute nodes, a request from the first compute node for at least a portion of a particular version of a data object; in response to receipt of the request, determine whether a second compute node of the plurality of compute nodes is mapped to a plurality of data object addresses that includes an address associated with the data object based on mapping information between the plurality of compute nodes and the plurality of data object addresses; when the determination is affirmative, redirect the request to a second compute node interface associated with the second compute node; receive, from a third compute node interface associated with a third compute node of the plurality of compute nodes, a response to the request comprising the at least a portion of the particular version of the data object; and provide, to the first compute node, the response to the request.

Example 31 may include the subject matter of Example 30, and may further include wherein the at least a portion of the particular version of the data object is stored in at least one of the third compute node or a data object cache included in the third compute node interface.

Example 32 may include the subject matter of any of Examples 30-31, and may further include wherein to receive the response to the request from the third compute node interface comprises to receive the response to the request from the third compute node interface when the at least a portion of the particular version of the data object is absent in the second compute node and the second compute node interface and the second compute node interface redirected the request to the third compute node interface based on data object version location information associated with the data object tracked and maintained in the second compute interface.

Example 33 may include the subject matter of any of Examples 30-32, and may further include wherein the plurality of instructions, in response to execution by the one or more processors of the first compute node interface, further cause to: retain the request, in the first compute node interface, when the first compute node is mapped to the address associated with the data object in accordance with the mapping information; and obtain the at least a portion of the particular version of the data object from a data object cache included in the first compute node interface.

Example 34 may include the subject matter of any of Examples 30-33, and may further include wherein the data object comprises a file, a page, a document, a tuple, or a unit of data.

Example 35 may include the subject matter of any of Examples 30-34, and may further include wherein, when the first compute node is mapped to the plurality of data object addresses that includes the address associated with the data object in accordance with the mapping information, the first compute node interface includes first data object version location information associated with respective data objects of a plurality of data objects associated with the plurality of data object addresses mapped to the first compute node.

Example 36 may include the subject matter of any of Examples 30-35, and may further include wherein the first data object version location information includes, for each first data object of the plurality of data objects mapped to the first compute node, one or more of: a valid bit, a data object identifier, an address range associated with the first data object, a creator compute node of the first data object, sharers compute nodes to which the first data object was provided, identifiers of versions of the first data object provided to respective sharers compute nodes, an identifier of a latest version of the first data object, an identifier of a compute node currently storing the latest version of the first data object, or an identifier of a version of the first data object locally cached in the first compute node interface when locally cached in the first compute node interface.

Example 37 may include the subject matter of any of Examples 30-36, and may further include wherein the request includes a start address and an address range to specify the at least a portion of the particular version of the data object, and wherein the at least a portion of the particular version of the data object comprises a particular portion of a single data object, a single data object, or more than one data object.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

We claim:

1. An apparatus comprising:
a first compute node interface to be communicatively coupled to a first compute node to receive a request from the first compute node for at least a portion of a particular version of a data object, wherein the first compute node interface is to include mapping information and logic, wherein the logic is to redirect the request to a second compute node interface associated with a second compute node when the second compute node is mapped to a plurality of data object addresses that includes an address associated with the data object in accordance with the mapping information, and
wherein the first compute node is to receive, as a response to the request, the at least a portion of the particular version of the data object from a third compute node interface associated with a third compute node.

2. The apparatus of claim 1, wherein the at least a portion of the particular version of the data object is stored in at least one of the third compute node or a data object cache included in the third compute node interface.

3. The apparatus of claim 1, wherein the third compute node interface is to provide the response when the at least a portion of the particular version of the data object is absent in the second compute node and the second compute node interface and the second compute node interface redirects the request to the third compute node interface based on data object version location information associated with the data object tracked and maintained in the second compute interface.

4. The apparatus of claim 3, wherein the first compute node interface includes a data object cache that stores the at least a portion of the particular version of the data object, wherein the logic is to retain the request in the first compute node interface when the first compute node is mapped to the address associated with the data object in accordance with the mapping information, and wherein the logic is to obtain, as the response to the request, the at least a portion of the particular version of the data object from the data object cache and to provide the response to the first compute node.

5. The apparatus of claim 4, wherein the logic comprises an application specific integrated circuit (ASIC), programmable array logic (PAL), field programmable gate array (FPGA), circuitry, on-chip circuitry, hardware, or firmware.

6. The apparatus of claim 1, wherein, when the first compute node is mapped to the plurality of data object addresses that includes the address associated with the data object in accordance with the mapping information, the first compute node interface includes first data object version location information associated with respective data objects of a plurality of data objects associated with the plurality of data object addresses mapped to the first compute node.

7. The apparatus of claim 6, wherein the first data object version location information includes, for each first data object of the plurality of data objects mapped to the first compute node, one or more of: a valid bit, a data object identifier, an address range associated with the first data object, a creator compute node of the first data object, sharers compute nodes to which the first data object was provided, identifiers of versions of the first data object provided to respective sharers compute nodes, an identifier of a latest version of the first data object, an identifier of a compute node currently storing the latest version of the first data object, or an identifier of a version of the first data object locally cached in the first compute node interface when locally cached in the first compute node interface.

8. The apparatus of claim 1, wherein the request includes a start address and an address range to specify the at least a portion of the particular version of the data object, and wherein the at least a portion of the particular version of the data object comprises a particular portion of a single data object, a single data object, or more than one data object.

9. A computerized method comprising:
receiving, at a first compute node interface associated with a first compute node of a plurality of compute nodes, a request from the first compute node for at least a portion of a particular version of a data object;
in response to receipt of the request, determining whether a second compute node of the plurality of compute nodes is mapped to a plurality of data object addresses that includes an address associated with the data object based on mapping information between the plurality of compute nodes and the plurality of data object addresses;
when the determination is affirmative, redirecting the request to a second compute node interface associated with the second compute node;
receiving, from a third compute node interface associated with a third compute node of the plurality of compute nodes, a response to the request comprising the at least a portion of the particular version of the data object; and
providing, to the first compute node, the response to the request.

10. The method of claim 9, wherein the at least a portion of the particular version of the data object is stored in at least one of the third compute node or a data object cache included in the third compute node interface.

11. The method of claim 9, wherein receiving the response to the request from the third compute node interface comprises receiving the response to the request from the third compute node interface when the at least a portion of the particular version of the data object is absent in the second compute node and the second compute node interface and the second compute node interface redirected the request to the third compute node interface based on data object version location information associated with the data object tracked and maintained in the second compute interface.

12. The method of claim 11, further comprising:
retaining the request, in the first compute node interface, when the first compute node is mapped to the address associated with the data object in accordance with the mapping information; and
obtaining the at least a portion of the particular version of the data object from a data object cache included in the first compute node interface.

13. The method of claim 12, wherein the data object comprises a file, a page, a document, a tuple, or a unit of data.

14. The method of claim 9, wherein, when the first compute node is mapped to the plurality of data object addresses that includes the address associated with the data object in accordance with the mapping information, the first compute node interface includes first data object version location information associated with respective data objects of a plurality of data objects associated with the plurality of data object addresses mapped to the first compute node.

15. A system comprising:
first, second, and third compute node interfaces communicatively coupled to each other; and
first, second, and third compute nodes associated with and communicatively coupled to respective first, second, and third compute node interfaces,
wherein the first compute node is to generate a request for at least a portion of a particular version of a data object, wherein the first compute node interface is to receive the request from the first compute node and to forward the request to the second compute node interface when the second compute node is mapped to a plurality of data object addresses that includes an address associated with the data object, and wherein the first compute node interface is to receive, as a response to the request, the at least a portion of the particular version of the data object from one of the second compute node interface or the third compute node interface.

16. The system of claim 15, wherein the second compute node interface is to provide the response to the first compute node interface when the at least a portion of the particular version of the data object is stored in at least one of the second compute node or a data object cache included in the second compute node interface.

17. The system of claim 15, wherein the third compute node interface is to provide the response to the first compute node interface when the at least a portion of the particular version of the data object is absent in the second compute node and the second compute node interface and the second compute node interface redirects the request to the third compute node interface based on data object version location information associated with the data object tracked and maintained in the second compute interface.

18. The system of claim 15, wherein the first compute node interface refrains from forwarding the request to the second compute node interface when the first compute node is mapped to the address associated with the data object, and wherein the at least a portion of the particular version of the data object is stored in a data object cache included in the first compute node interface and is to be obtained to be the response to the request.

19. The system of claim 15, further comprising a switch, and wherein the first compute node interface is to receive the response from one of the second or third compute node interfaces via the switch, and wherein the first compute node interface is to provide the response to the first compute node.

20. The system of claim 15, wherein, when the first compute node is mapped to the plurality of data object addresses that includes the address associated with the data object, the first compute node interface includes first data object version location information associated with respective data objects of a plurality of data objects associated with the plurality of data object addresses mapped to the first compute node.

21. The system of claim 20, wherein the first data object version location information includes, for each first data object of the plurality of data objects mapped to the first compute node, one or more of: a valid bit, a data object identifier, an address range associated with the first data object, a creator compute node of the first data object, sharers compute nodes to which the first data object was provided, identifiers of versions of the first data object provided to respective sharers compute nodes, an identifier of a latest version of the first data object, an identifier of a compute node currently storing the latest version of the first data object, or an identifier of a version of the first data object locally cached in the first compute node interface when locally cached in the first compute node interface.

22. The system of claim 15, wherein the request includes a start address and an address range to specify the at least a portion of the particular version of the data object, and wherein the at least a portion of the particular version of the data object comprises a particular portion of a single data object, a single data object, or more than one data object.

23. An apparatus comprising:
in response to receipt of a request from a first compute node for at least a portion of a particular version of a data object, means for determining whether a second compute node of a plurality of compute nodes is mapped to a plurality of data object addresses that includes an address associated with the data object based on mapping information between the plurality of compute nodes and the plurality of data object addresses;
when the determination is affirmative, means for redirecting the request to a second compute node interface associated with the second compute node; and
means for receiving, from a third compute node interface associated with a third compute node of the plurality of compute nodes, a response to the request comprising the at least a portion of the particular version of the data object when the at least a portion of the particular version of the data object is absent in the second compute node and the second compute node interface and the second compute node interface redirected the request to the third compute node interface based on data object version location information associated with the data object tracked and maintained in the second compute interface.

24. The apparatus of claim 23, further comprising:
means for retaining the request when a first compute node of the plurality of compute nodes is mapped to the address associated with the data object;
means for locally obtaining the at least a portion of the particular version of the data object to be the response; and
means for providing the response to the first compute node.

25. The apparatus of claim 23, wherein the request includes a start address and an address range to specify the at least a portion of the particular version of the data object, and wherein the at least a portion of the particular version of the data object comprises a particular portion of a single data object, a single data object, or more than one data object.
